(19) United States
(12) Patent Application Publication
(10) Pub. No.: US 2024/0047968 A1
(43) Pub. Date: Feb. 8, 2024

(54) Method for optimizing the consumption of renewable energy

(71) Applicant: Izi Smart Solutions S.r.l., Lucca (LU) (IT)

(72) Inventor: Giacomo Agostini, Porcari (LU) (IT)

(21) Appl. No.: 18/361,635

(22) Filed: Jul. 28, 2023

(30) Foreign Application Priority Data
Aug. 4, 2022 (IT) 102022000016680
Jul. 27, 2023 (EP) 23188075

(51) Int. Cl. H02J 3/14; H02J 3/00

(52) U.S. Cl. CPC H02J 3/144; H02J 3/003; H02J 3/004; H02J 2300/20

(57) ABSTRACT

A method for optimizing consumption of electrical energy in a dwelling from renewable sources includes determining electrical energy consumption in the dwelling within a first time interval based on historical data; determining electrical energy production from the renewable sources in the first time interval based on historical data; entering, in an electronic control unit, one or more utilities present in the dwelling and for which to generate an activation and/or deactivation schedule in a second period of time after the first period of time; and generating the activation and/or deactivation schedule as a function of the historical data of energy consumption and production and forecasted weather data for the second time interval, so that the activation and/or deactivation schedule indicates, within the second time interval, a series of times and/or time sub-intervals distributed within the second time interval when to activate and/or deactivate one or more of the utilities.

### FIELD OF THE INVENTION

The present invention concerns the technical sector related to the calculation of consumption within a residential unit in general, both for office and for housing use.

In particular, the invention refers to a particular system capable of monitoring consumption in a precise manner in order to control, in said residential unit provided with renewable energy sources, how much consumed energy is supplied by produced renewable energy and how much energy is instead drawn from the electricity grid.

More in particular, a system according to the invention is not limited only to monitoring energy consumption of a dwelling and of the production of renewable energy, but primarily puts in place calculation logics that allow maximizing the exploitation of energy produced from renewable sources, generating and recommending a consumption schedule.

### BACKGROUND OF THE INVENTION

It is known that many housing units use renewable energy sources, that is, they produce clean energy.

Such renewable energy sources can include, for example, photovoltaic panels, which are now widespread in many housing units in general. Thanks to photovoltaic panels, it is possible to produce electric current from the energy of the sun and this electrical energy is stored and provided to power utilities.

Other renewable sources that can be used and/or are used in dwellings can derive from wind generation that allows electric current to be produced through the wind rotating a wind blade or a rotating element in general.

These dwellings, therefore, have a certain quantity of electrical energy coming from renewable sources that is or can be used for various domestic utilities.

However, the use of domestic electrical utilities (lights in general, household appliances, air conditioners, etc.) takes place at different times and according to need.

An attempt is often made to optimize consumptions but identifying the consumption that is actually occurring is not always easy and is not easy to schedule consumptions smartly in order to exploit exclusively or for the most part the stored clean energy without using network energy.

The result, therefore, is that often one has no idea of how much consumption has been made, whereby all the energy coming from the renewable source becomes used up, paying then dearly, in electricity charges, the excess energy consumed that comes from the grid.

There are some solutions in use that, however, suffer from some limitations, such as those disclosed in Italian publication 102018000003898.

For example, there are solutions that monitor energy consumption and the production from renewable sources with precision, but the limit of the prior art is that those solutions are based on monitoring and implementing logics in real time and are therefore unable to predict a long-term estimate.

For example, an example of real-time logic might be:

Building with:

Photovoltaic panels (FV);

Sensor to detect the total consumption of the building in real time (CG);

Sensor to detect photovoltaic production of the building in real time (PF);

A household appliance (e.g. a washing machine), for example electronically controllable remotely (L);

A control unit that implements and executes the efficiency logic (C).

It is assumed that at a certain time of the day, for example at 12:00 p.m., the sensor (CG) reads a consumption of 2 kW against a production detected by the sensor (PF) equal to 5 kW. The control unit (C), at this point, calculates that the available renewable energy margin is equal to 3 kW, and based on the implemented logic it decides to activate the related household appliance (L) remotely. Although this solution is functional, the implementation is carried out on the basis of logics that are based exclusively on the instantaneous state of the sensors.

The limit of this management is evident: atmospheric conditions also vary considerably the production of energy day by day, and with no vision in the future it is impossible to implement “forward-looking” logics. The user, who for example has to do about twenty wash loads a week, is unable to predict a priori what will be the best day to do the laundry and has to hope to be at home at the instant in which the system will notify him/her or her that said instant “is a good time to do the washing”.

A household appliance such as a washing machine must in fact be pre-loaded with the clothes and garments to be washed, it must be programmed, and the detergent must be prepared. It is clear that in a system that detects a measurement in real time, even having a remote activation system, it is clear that the user must have previously set up everything for an activation with the risk that then, however, the expected activation conditions have not taken place.

### SUMMARY OF THE INVENTION

It is therefore an object of the present invention to provide a method for scheduling consumptions that allows maximizing the consumption of energy coming from domestic renewable sources.

In particular, it is an object of the present invention is to provide a method that allows maximizing the consumption coming from renewable sources, allowing in particular a long-term forecast of consumptions and thus allowing scheduling a sequence of switchings on and/or off of utilities in a scheduled manner over time so as to make the most of renewable sources.

These and other objects are obtained with a method for optimizing electrical energy consumption coming from renewable sources present in a dwelling in general as disclosed herein.

In one embodiment, said method comprises the following steps:

Determination of an electrical energy consumption in a dwelling based on historical detection data in a predetermined time interval;

Determination of a production of energy from renewable sources present and in use in said dwelling based on historical data in said predetermined time interval.

Advantageously, in this way a set of historical reference data relating to energy consumption and production is obtained.

The method provides, for example in an initial step and for example “one-off”, for an entry in a control unit, for example installed on site or virtual such as in a cloud system, of one or more domestic utilities (200, 300) present in the dwelling, for which to generate a programmed activation/deactivation schedule.

Advantageously, the utilities can be entered only once in the system and then, once acquired, the system will work as described below with these utilities. The utilities to be entered can be modified at any time.

A program is then generated for activating/deactivating said utilities in a predetermined time interval (T) subsequent to determining the historical consumption and energy production.

Said program (or schedule as the case may be) is obtained as a function of said previously calculated historical energy consumption and production and further as a function of one or more pieces of weather data in the time interval (T) in which to carry out the program, so that the programming indicates, within said time interval (T) relating to the program, a series of times and/or time subintervals distributed in said time interval (T), in which to activate/deactivate one or more of said utilities in such a way as to maximize the energy consumption coming from the renewable sources of the dwelling.

In this way, the activation is programmed to draw at least in part from energy coming from the renewable sources.

In this way, an attempt is made to maximize and optimize consumption by taking energy as much as possible from the renewable sources.

Likewise, the switching off is programmed to save energy, for example when the renewable source is scarce (for example because the estimate indicates low production due to adverse weather conditions).

In this manner a long-term schedule is created, for example of one week, which indicates exactly instants or a time interval in which the switching on of one or more specific utility/ies will be powered mainly or entirely by energy coming from the renewable sources.

There is therefore a specific function (or calculation algorithm) that depends on the previously mentioned parameters, i.e., the utilities entered for which to make the consumption schedule and the consumption and energy production log, taking into account the effect of weather conditions on energy production.

The calculation algorithm, therefore, provides a program or schedule, as the case may be, visible on screen, which indicates within the expected frame of time, for example a week, exact times of switching on and/or off the household appliances or utilities in order to switch them on when there is availability of energy from renewable sources and to switch them off when such energy is expected to drop.

This is a consequence of the historical calculation made of the consumptions and energy accumulated in the same historical reference period, as well as the weather factors that influence this calculation.

If in a specific time interval there is, at a certain hour of said time interval, an energy surplus, the software program can indicate a time or time slot as suitable for the switching on and use of household appliances and utilities whose consumption is compatible with a surplus of produced energy. This is conditioned by the corrective parameters related to weather conditions, which are important variables to take into account. If, in fact, historically, an energy surplus from available renewable sources is indicated, the corrective factor of the weather corrects this data that could, for example, increase if weather conditions are favorable or could decrease in adverse conditions.

In any case, this enables, in the long term, programming an optimization of the consumptions coming from renewable sources, minimizing consumptions from the electric grid.

It is clear that this solution, in addition to allowing considerable cost savings, has a considerable beneficial impact on the environment.

Owing to this solution, therefore, all the aforementioned technical problems are solved.

In particular, owing to detected data of real consumption and of energy production from renewable sources (historical data) together with one or more forecast weather parameters, it is possible to estimate a consumption program.

The calculations of the historical data are carried out in a certain time interval, minute by minute and/or second by second along a specific time frame.

Therefore, this allows knowing, in a precise way, instant by instant what on average energy consumption and production is, for example within a week frame.

Therefore, as a function of the utilities entered in the control unit and their consumptions, the system can easily elaborate a program in which the exact times at which one or more specific household appliances or utilities can be switched on are indicated, the whole also as a function of the weather data.

In fact, being known in a certain time sub-interval how much energy on average is consumed and how much energy is produced, in case of an energy surplus the system can easily recommend switching on a specific utility that is compatible with this energy surplus, thus giving, with reasonable certainty, a consumption schedule over time that guarantees that said consumption is made when there is availability of energy coming from renewable sources.

Unlike the prior art, detection is not done instant by instant.

The historical data are processed only once to generate, as a function of the entered utilities and their consumptions, a long-term program that can be for example of one day, of a fraction of one day or even of two or more days, for example one week, one month or more months.

It is clear that, the longer the time interval in which the switching on/off program of the utilities is included, the lower the expected accuracy.

For example, a historical reference estimate between consumption and accumulation of energy can be repeated continuously or discretely, for example week by week, in order to generate programs, for example, of a subsequent week with a reasonable precision.

In this way, in advance, a user has a precise program of switching on/off the utilities.

In particular, having a smart system capable of indicating precisely, in real time, the consumption supported by the renewable sources is essential for understanding when consumption is in excess thereof and when the consumption of non-renewable energy will start.

Advantageously said utilities may comprise one or more of the following:

One or more air conditioning units;

One or more household appliances.

Advantageously said historical determination of the electrical energy consumption can be made through a sensor (CG) that measures in real time the consumption carried out.

Advantageously, said historical determination of the production of energies from renewable sources can be carried out with a sensor (PF) that measures in real time the energy produced.

Advantageously, said generation of the activation and/or deactivation schedule can be carried out by a specific control unit that receives in input the data coming from said sensors (CG) and (PF) and said one or more forecast weather data, said control unit processing said data according to specific function (f).

Advantageously, the generation of the activation and/or deactivation schedule can be carried out by a specific control unit that receives the historical data and said one or more forecast weather data.

Advantageously, said control unit processes said input data according to specific function (f).

In all cases, advantageously, the control unit can be installed on site or, alternatively, can be virtual, for example in the cloud.

Advantageously, said generation of the activation and/or deactivation schedule may provide for the entry of one or more utilities through a control panel communicating with the control unit or through a specific mobile device app, when a cloud control unit is present.

Advantageously, said schedule can be visible on screen and indicates, based on the set time interval, a time slot and related day on which to activate and/or deactivate certain utilities.

The screen can be that of an on-site control panel as well as that of a mobile device in the case of the app.

Advantageously, said historical reference data are repeated continuously or at predetermined time intervals.

The invention further relates to an assembly for optimizing the electrical energy consumption coming from renewable sources in a dwelling in general, said assembly comprising:

At least one first sensor (GC) adapted to detect energy consumption in real time by the utilities in use in said dwelling;

At least one second sensor (PF) adapted to detect in real time energy production from renewable energy sources that have been set up, in use, in said dwelling;

A control unit communicating with said first and second sensor to receive as input the data measured by said sensors, said control unit further receiving as input one or more weather data;

Wherein the control unit is programmed to calculate, based on said data received as input from the sensors, a historical reference data of electrical energy consumption and electrical energy production from renewable sources occurred in said predetermined time interval (t0) in which said data were acquired;

Wherein said electronic control unit is further programmed to acquire as input one or more data elements related to one or more utilities (200, 300) present, in use, in the dwelling and of which to generate an activation and/or deactivation schedule over time;

Said control unit being therefore programmed to generate said activation and/or deactivation schedule of said utilities in a time interval (T) subsequent to that (t0) of detection of the historical data, said activation and/or deactivation schedule being obtained as a function of:

Said historical data of energy consumption and production;

One or more forecast weather data related to said time interval (T) in which to generate the activation and/or deactivation schedule;

In such a way that said schedule indicates, within said time interval (T), a series of times and/or time subintervals distributed in said time interval (T), in which one or more of said entered utilities can be activated or deactivated.

Advantageously, the control unit estimates the times and/or the time sub-intervals in which it has been verified that there is an energy surplus, wherein, based on the calculated energy surplus and the consumptions of the entered utilities, it indicates in a report which utilities to activate and/or deactivate in the time interval.

The present invention also relates to a system for optimizing electrical energy consumption coming from renewable sources in a dwelling, said system comprising:

A dwelling provided with one or more utilities in general;

An assembly according to one or more of the above features.

### BRIEF DESCRIPTION OF THE DRAWINGS

The invention, in one or more of the embodiments thereof, will be described below in accordance with the following drawings:

FIG. 1 schematically shows a dwelling 100, therefore, a local unit, with one or more photovoltaic panels (FV) that produce a certain energy quantity schematized with the storage battery. FIG. 1 also shows an electrical outlet to indicate the mains energy; and schematizes some household appliances (200, 300) and the sensor (CG) that reads and detects the consumptions of the dwelling in real time;

FIG. 2 schematizes the photovoltaic panels (FV) irradiated by solar rays and, therefore, in energy production condition. FIG. 2 also schematizes the sensor (PF) that detects energy production in real time;

FIG. 3 schematizes the control unit that receives as input the measurements of the sensors (CG) and (PF);

FIG. 4 and FIG. 5 schematize a graph to highlight the historical data (historical_data) of energy consumption and production that are processed by the control unit as a function of the input data received through the measurements of the sensors (CG) and (PF); and show, in particular, on a Cartesian graph, reference historical data until a time t0, which is then followed by the calculation after time t0 which is based, in part, on the historical data (the part subsequent to to indicated as a forecast);

FIG. 6 further schematizes the control panel through which all the utilities and their specifications can be manually entered (e.g. dimensions/powers, etc.); and shows how those data are transferred to the control unit that has processed the historical data of energy consumption and production and that further receives weather data as input in order to elaborate a schedule of the uses by the household appliances according to a specific forecast time program that is a function of said input data, i.e., the utilities entered, the historical data and the weather data;

FIG. 7 schematizes in a graph an example of one-day programming highlighting an area of consumptions estimated historically over a time frame and, in the same time frame, a graph of the renewable energy produced historically together with the correction of the weather, so as to highlight with solid color the area of energy surplus that one can have in specific time intervals; accordingly, knowing the household appliances that one wants to use, in particular those entered in the control panel, and their consumptions, the processor can implement a time program in a specific period of time indicating if and which household appliances to use and the recommended time of use, in order to make the most and best use of the energy surplus. Therefore, if some household appliances experience an excessive consumption in the specific time interval, the program selects the use of other appliances entered in the list that are compatible with the energy surplus;

FIGS. 7A and 7B show a few graphs suitable for understanding an implementation of the calculation that is performed.

### DETAILED DESCRIPTION OF EMBODIMENTS OF THE INVENTION

The invention relates to an innovative method of generating a forecast of energy production by domestic renewable energy sources and to a forecast of energy consumption within a building. Based on this forecast, a system can calculate the best way to use household appliances within the forecast window, so as to maximize the self-produced consumption of renewable energy.

A forecasting system according to the invention has the great advantage of enabling a user to have in advance an estimate of times and/or days in which to carry out certain operations, so allowing him/her to be able to best manage himself/herself also based on his/her plans and presence in person at home.

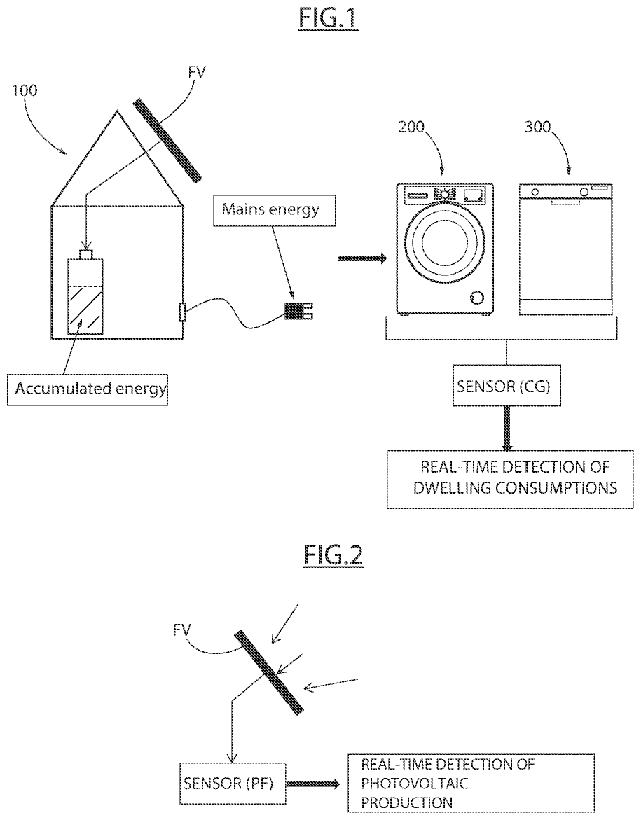

In FIG. 1, a dwelling 100 is schematized having, by way of an example, energy accumulated by solar panels (FV) in addition to energy that is instead related to the normal mains electricity grid.

As schematized in FIG. 1, a part of the energy is therefore accumulated from such renewable sources, i.e., the photovoltaic panels (FV) while another part of the energy can come from and is available from the normal electricity grid.

The household appliances and all the domestic utilities have a predetermined consumption.

FIG. 1 also schematizes some household appliances including, by way of a non-limiting example, a washing machine 200 and a dishwasher 300.

In accordance with the invention, there is a first sensor (GC) which is connected, and therefore communicating, with the domestic utilities. The sensor (CG) is therefore configured to detect and/or store consumption by the utilities.

The utilities shown in the schematization of FIG. 1 are obviously only a non-exhaustive and non-limiting example.

In FIG. 2, the dwelling is also provided with one or more renewable energy production systems (FV) including, by way of a non-limiting example, photovoltaic panels (FV) (one or more than one).

It is clear that, in the invention, the photovoltaic panel is only an example since the dwelling can in fact include other systems as an alternative or in addition to the panels, for example, wind systems.

In all cases, regardless of how many and which renewable energy production systems are present, in accordance with the invention there is a sensor (PF) which is connected to such renewable energy production systems in order to detect and/or store in real time the energy production that is actually made.

The system therefore makes it possible to monitor and maximize consumption that comes from the renewable sources.

In particular, the system can be specifically programmed to perform certain calculation operations that allow a forecast to be made over a specific time frame.

Assuming, therefore, the presence of the aforementioned photovoltaic panels (FV), these are connected to the sensor (PF) to detect and thus measure photovoltaic production in real time (and/or from any other renewable sources if present).

The sensor (CG) is arranged to detect the overall consumption of the building in real time.

In a first step, historical data related to the consumptions are extrapolated, taking advantage of the real-time measurements detected by the sensor (GC) and, also, historical data related to the renewable energy produced through the real-time measurements of the sensor (FV).

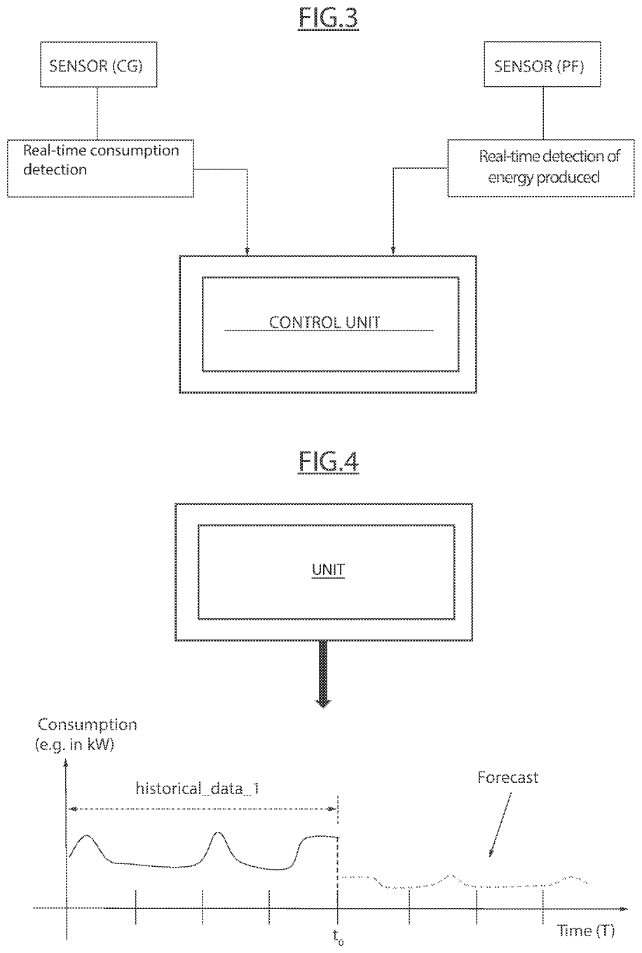

FIG. 3 schematizes a control unit.

The control unit, as is known in the art, is provided with a specific programmed or programmable processor.

The processor may be specifically programmed in accordance with the following description.

As schematized by FIG. 3, the control unit (also identified here simply as “unit”) receives measurement data in real time coming from the sensors, in particular from the sensor (CG) that detects in real time the consumptions of the dwelling and from the sensor (FV) that detects the amount of renewable energy produced by the energy systems installed in the dwelling (for example solar panels, wind energy and/or, more generally, other systems).

In a first step, therefore, the processor can create a log of the consumptions and a log of the energy produced in a specific time interval (t0).

More particularly, as schematized in FIG. 4, the real-time measurements of the sensor (CG) allow the processor to create a data-log highlighting a consumption over a specific time frame, for example estimated over one week (historical_data_1). The data-log therefore contains, instant by instant, in the predefined time frame, a log of energy consumption.

The methodologies for calculating an average consumption, based on the real-time measurement data coming from the sensor (CG), can be different and the person skilled in the art will be able to implement the calculation algorithm that he/she deems the most suitable.

In any case, as schematized in FIG. 4, a data-log of data is then extrapolated indicating a consumption trend measured over a specific time frame, for example, as said, one week.

Obviously, although not schematized in the figure, the consumption measurement can be calculated precisely over any time frame.

From the schematization of FIG. 4 it is therefore evident, by way of example, that a calculation of consumptions in a week frame can be made in which some peaks show an extra measurement of consumption linked to a certain life pattern of the subject, for example because at certain moments of the day he/she uses more specific household appliances.

Similarly, as per the schematization in FIG. 5, the control unit performs a measurement of energy production by the renewable sources in a predetermined time frame, preferably over the same previous time interval (historical_data_2).

So, historical data of energy consumption and production can be determined in a specific historical time interval which, preferably, is the same for both of the aforementioned measurements.

In particular, the data-log [historical_data_1] indicates, instant by instant, an energy consumption calculated over a certain time frame (0-t0) while the data-log [historical_data_2] indicates instant by instant the calculation of the historical energy production of the renewable sources in the same time frame (0-t0).

Historical data_2 and historical data_1 also take into account, of course, the structural parameters of the utilities and renewable energy sources.

On the basis of said generated historical data, a forecast of the future instantaneous consumption values over a settable time horizon, for example one week, is then generated.

FIG. 4, as said, schematizes a graph of instantaneous consumptions that has been hypothesized by the processor on the basis of the data extrapolated by the sensor (CG).

The sensor PF, in turn, is the sensor that reads the consumptions related to the renewable source, such as for example one or more photovoltaic panels, from which the estimate of FIG. 5 follows. It is therefore possible to create, also in this case and as schematized in FIG. 5, a time horizon of instantaneous values of production of current by the system(s) in question. This can take into account the structure and the type of plant in question (therefore, for example, number and power dimensions of the solar panels).

For example, the time horizon for the historical calculation can be one week.

In this way, as schematized by FIGS. 4 and 5, there are two temporal calculations based on historical data.

One is that of the building's consumption and, therefore, how much the utilities generally consume over a certain time frame, and the other one is how much the renewable energy production over a fixed time frame is, for example one week.

A particularly innovative element of the invention consists further in having the calculation system (therefore the calculation function as a whole) integrated and taking into consideration meteorological forecasts including, for example sun, winds and/or temperatures.

In fact, it is known that the solar panels produce energy as a function of the solar rays from which they are hit. It is therefore known that energy production is strongly influenced by the weather conditions since a rainy day leads to a very low energy production compared to a hot and sunny day condition.

The same is true for the wind, when wind systems are present among the renewable energy production systems.

Therefore, the calculation algorithm that generates the consumption program, i.e., the consumption schedule, is based not only on the previous historical data inherent in energy consumptions and production, as indicated above, but also as a function of weather estimates.

The control unit can therefore be connected, for example through the interne, to weather information sources that in real time continuously or at predetermined time intervals, send parameters correlated to the presence or absence of the sun, the temperatures and the presence or absence of wind as well as any other detectable weather parameters (for example humidity).

The calculation algorithm therefore takes these parameters into account, which acquire a specific weight in the calculation function.

When, for example, it is envisaged in the time frame for which the calculation of the program is carried out (for example one week) having sunny weather and strong winds, an estimate of a consumption program can be made with greater precision using, for example, corrective factors that can be entered in the formula of the function and that result in an increase of the available energy possibilities. On the contrary, low winds and/or rain or overcast sky lead(s) to a corrective factor that decreases energy availability, thereby modifying the program.

The calculation function can be any and a person skilled in the art will be able to find the one most suitable one for his/her needs.

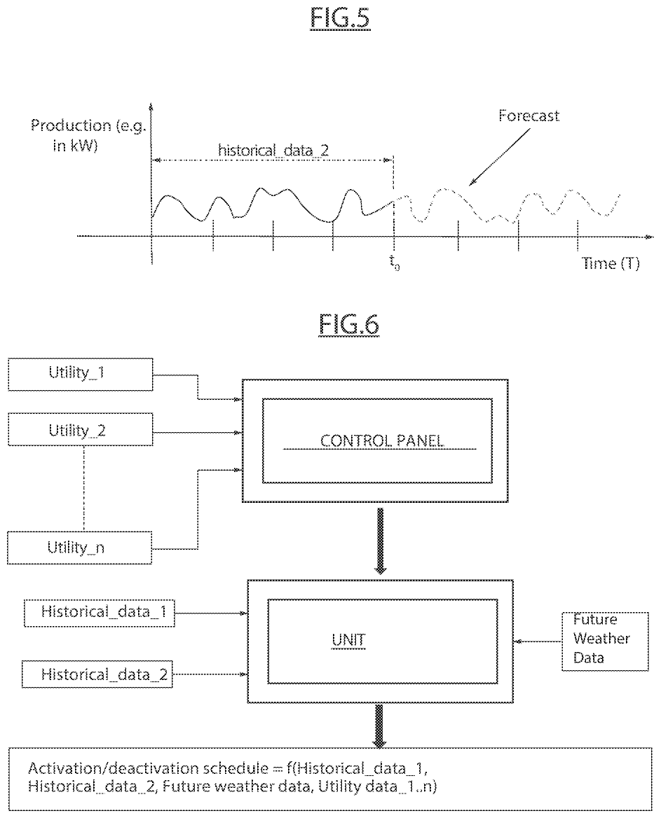

FIG. 6 schematizes inputs and outputs.

Starting from forecasts not only of the weather but also of energy consumptions and production as introduced above, the processor can now generate a “Consumption Schedule” over a set time horizon, for example one week and after the time interval on which the historical estimate was made.

In particular, it is possible to enter, for example from the control panel, all the utilities present in the dwelling with their relative consumption.

FIG. 6 schematizes a control panel normally present for this type of system.

It is managed electronically and is provided with a panel through which to read the data and/or a corresponding push-button panel for data entry.

The panel, therefore, allows entering the utilities in general (e.g., refrigerator, iron, etc.).

The control panel communicates with the control unit that processes the estimate calculation.

In particular, FIG. 6 therefore shows the utilities from 1 to n that can be entered in the control panel and of which a program of use over time is to be drawn up.

More particularly, the relative consumptions of each utility can be entered.

For example, the control panel can already envisage a list of utilities, divided by brand and model, which can be selected by the user and which, therefore, already contain as preset all the consumption values necessary for the above-described calculation.

The user can then select, for example, his/her type of air conditioner that he/she has installed, his/her refrigerator etc. by checking it from a predefined list.

Said consumption data of the entered utilities are therefore acquired by the related control unit with its processor which, through the historical estimates that were previously introduced, can easily implement a consumption forecast calculation.

In particular, the historical data processed and the weather data together with the characteristics of the entered utilities allow the creation of a calculation function.

The invention therefore includes a strategy, implemented by a control unit present within the dwelling, which has as output a “consumption schedule” over a defined and settable time horizon.

An example of a consumption schedule (of one week, generated on Sunday for the subsequent week) can for example be:

Monday:

at 8:34 a.m. switching on air conditioner in the living room

at 9:02 a.m. switching on washing machine

at 9:58 a.m. switching on air conditioner in the kitchen

at 10:45 a.m. switching off washing machine

at 10:56 a.m. switching on tumble dryer

at 12:03 p.m. switching off tumble dryer

at 2:34 p.m. switching off air conditioner in the living room

at 3:25 p.m. switching off air conditioner in the kitchen

Tuesday:

at 8:43 a.m. switching on air conditioner in the living room

at 9:24 a.m. switching on washing machine

at 9:54 a.m. switching on air conditioner in the kitchen

at 10:23 a.m. switching off washing machine

at 10:44 a.m. switching on washing machine

at 11:56 a.m. switching off washing machine

at 12:43 a.m. switching on tumble dryer

at 13:42 p.m. switching off tumble dryer

at 3:24 p.m. switching off air conditioner in the living room

at 4:45 p.m. switching off air conditioner in the kitchen

and so on until Sunday.

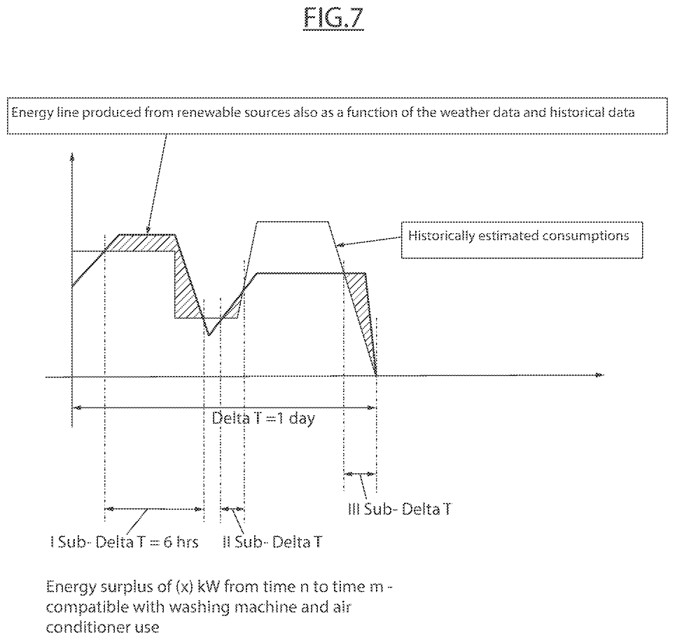

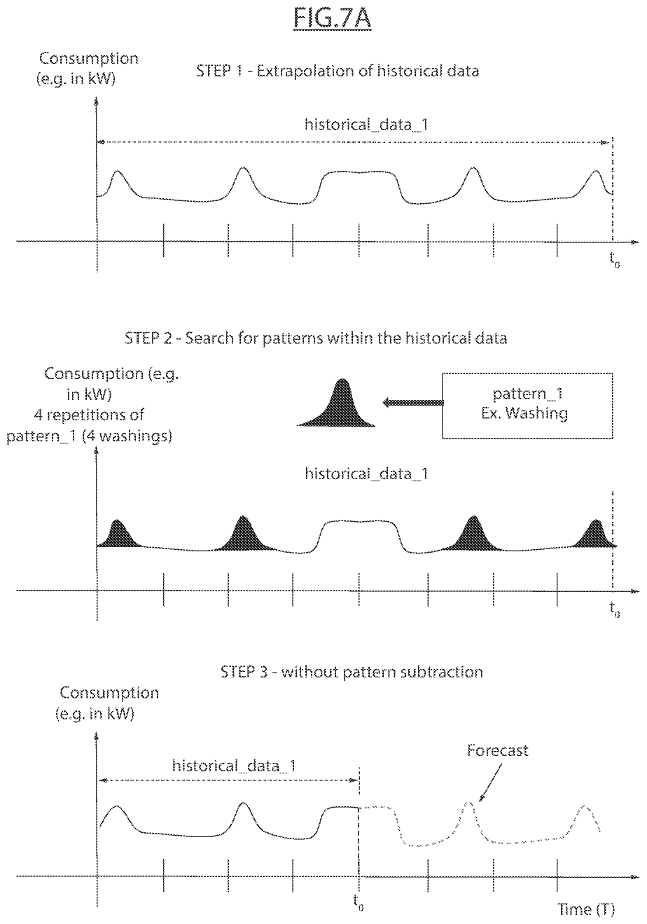

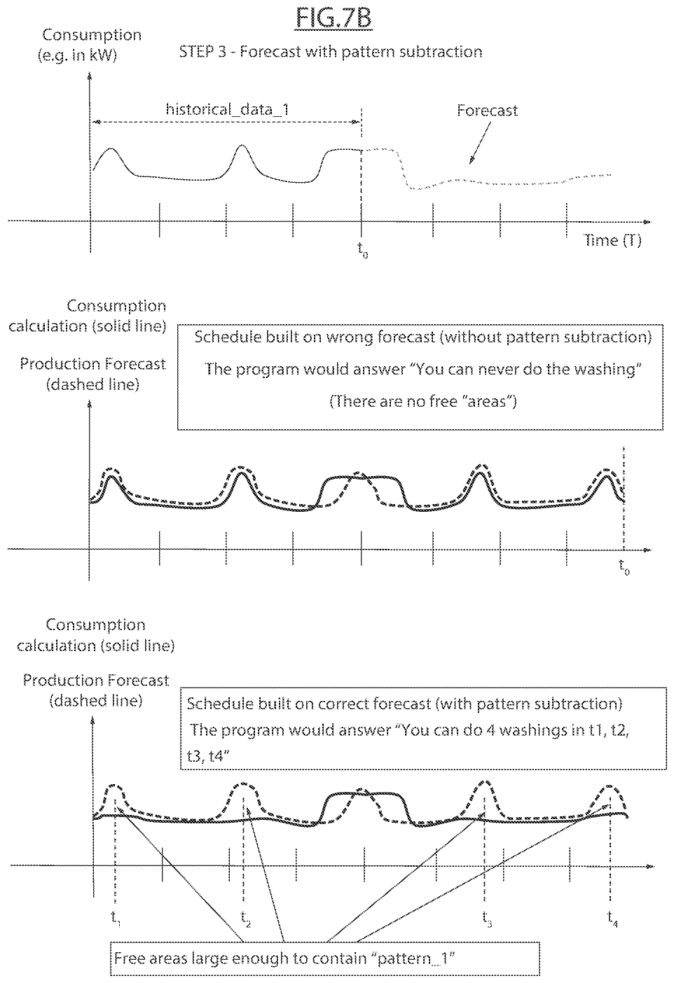

In fact, knowing a consumption in the dwelling and knowing a production of renewable energy over a time frame, it is easy, as per schematization in FIG. 7, to identify the areas where there may be an energy surplus related to energy production from renewable sources as a function of weather conditions and areas where, instead, the amount produced from renewable sources is lower than the value of actual consumption. From this, consequently, the processor can give as output a consumption program aimed at optimizing, by time slots, the consumption coming from renewable sources, being statistically known, as a function of historical consumptions, the historical average quantity of renewable energy produced.

The graph of FIG. 7, in two different colors, shows by way of example the line that delimits the area of the estimated consumptions and with an orange color the line that delimits the area of produced energy influenced by weather conditions, indicating with solid color the areas of energy surplus produced by renewable energies with respect to consumptions.

The example of FIG. 7 shows an estimate for a day but the estimate can be made over a longer time, generally a time compatible with the program that one wishes to generate, for example one week if the program that one wishes to implement runs from week to week.

Still in accordance with FIG. 7, some traits, called sub-delta, in which there is an energy surplus, are highlighted in solid color. FIG. 7 shows three of them by way of example and in the first one, by way of example, an energy surplus is shown lasting six hours.

In this way, the program can estimate, instant by instant, the time intervals in which there is an energy surplus, which is also quantified as the difference between consumption and energy produced.

Therefore, when the consumptions of the entered household appliances is known and other parameters are also known for some of them, such as operating time as in the case of a dishwasher, the system can estimate if and which ones among the household appliances can be used and which, instead, are to be deactivated in accordance with the program example that was provided above.

This way, the user has in advance a program of times and days (for example, a weekly program) in which he/she knows that he/she can switch on certain household appliances and/or switch off others and can, therefore, follow the provided schedule both manually and remotely.

Such schedule can be carried out manually in all dwellings where the utilities require an in-person activation (for example, in a washing machine that must be pre-loaded with the clothes to be washed, the detergent must be inserted and only after these steps it can be started remotely).

Additional utilities, such as air conditioners, can also be controlled via the app at a distance (therefore remotely), therefore, a communicative interface with this system can allow an automatic activation of all controllable utilities at a distance (remotely) according to the indicated program.

If, for example, in a weekly programming frame that has been provided the user checks which are the days and times of recommended activation of the washing machine, he/she can safely, from time to time, prepare in advance the load and then enable the program, remotely, to activate the washing machine.

The same applies for the dishwasher or other utilities in general.

As mentioned, the user can see the “consumption schedule” on a display, when provided, on the control panel of the control unit or through an app usable from a computer such as PC or a mobile device.

The user can also decide whether to use the “consumption schedule” as a guideline, manually implementing the scheduling, or allow the control unit to act for him/her, which will switch on and off the devices directly by communicating with them through an electronic remote control.

The forecast-based system, in addition to the previously discussed advantage of transmitting awareness to the user of what the future activations will be and when they will occur, bases the scheduling on optimization over an extended time horizon.

To clarify the preceding description, it should be mentioned that the historical data is implemented from time to time.

The historical consumption data can easily identify exactly the consumption habits of the user, as the consumption “patterns” clearly indicate which household appliance or utility is consuming and how much and for how long. The historical data, therefore, in addition to detecting consumption can easily provide information on the type of household appliance or utility in general that consumes, and how often consumption occurs.

In other words, the forecast program is based on historical data which, automatically, provides the number of activations/deactivations of the utilities and generates a program that is based and allocates those utilities most efficiently according to their frequency of use.

For example, the historical data can detect how many washings can be done in a week (for example twenty) and therefore the program allocates said twenty washings in the most efficient manner.

This is because the analysis of the consumptions allows highlighting consumption patterns that are easily identifiable utility by utility, which are different from one another.

Therefore, the log can also be used to replicate a program of use according to the detected historical frequency.

It can be seen that the historical data is updated with a periodic frequency or continuously since the historical data changes both as a function of weather data and as a function of the habits of the user. Therefore, the function that estimates and generates the schedule of use is a function that acquires as input historical data that from time to time are different and can be updated periodically.

By automatically acquiring, for example, statistical data indicating that the user needs about twenty washings per week, the system will concentrate the greatest occurrence near the days when greater production is expected. In regard to air conditioning, which alone takes up about 80% of the energy consumption of a dwelling, the advantage of working with forecasts is tangible and derives from being able to forecast and compensate for the days of low production with the days of greater production, for example: tomorrow it is sunny, in two days it will be rainy and in three days it will be sunny again. The system, by way of scheduling, will then provide for a greater accumulation in its program on the sunny days in order to, for example, recommend a use of the energy accumulated on a rainy day.

As previously discussed, in order to optimize accuracy, the above indicated statistical calculation based on consumption and on energy production can be repeated from time to time in so as to improve accuracy.

This is not only due to the fact that some “habits” can change over time but also as a function of the seasons where, obviously, there is greater and/or lesser consumption as well as greater and/or lesser energy production.

For example, in the summertime there is a greater consumption of air conditioning but there is also a greater accumulation of solar energy.

Reactivating each time, in predetermined time intervals, a repetition of the calculation for the estimation of the historical reference data provides for more precise estimations.

FIGS. 7A and 7B show an example of a calculation.

Starting from a calculation of the consumption (historical_data_1) in a specific period of time (0-t0), the system recognizes the consumption patterns entered in the control panel and from which to make the schedule, for example, the washing machine or other household appliances, as these have repeated occurrences over time which can be easily traced back, for example, using brands and models of the utilities.

It should also be noted that the control panel allows the entry of only and exclusively some utilities, i.e., those and only those whose consumption schedule is to be made while other utilities cannot be entered because they have an unpredictable usage or in any even a usage that cannot be programmed.

For example, in accordance with the invention, kitchen household appliances such as oven and/or induction cookers for the kitchen cannot be entered, as well as hair dryers.

That is because it is not practically possible to force a user to cook at a time at night or to dry his/her hair at night.

Some utilities are therefore excluded.

The subtraction of certain patterns is therefore only for those utilities entered by the user, in order to develop an effective program or schedule.

FIG. 7A, in step 2, shows the search and the recognition of the exemplary pattern of the washing machine and in any case of all and of only those patterns related to the specific utilities entered in the control panel and of which a schedule is to be made.

Step 3 of FIGS. 7A and 7B shows the forecast in the case of no pattern subtraction (incorrect case) and in the case of pattern subtraction (correct case).

If the recurring pattern (in the example of the washing machine) is not subtracted from the historical data of consumption, the final forecast (also a function of the historical estimate of the energy produced and weather data) is not true and would therefore lead to a forecast such as that of FIG. 7A step 3 with consequent calculation of the consumptions and produced energy, as a function also of weather forecast, which would carry the risk of presenting no possible free allocation area (see FIG. 7B “Schedule built on the wrong forecast (without pattern subtraction)”. FIG. 7B “Schedule built on the wrong forecast (without pattern subtraction)” shows in fact the calculated line of the consumptions and that of the produced energy, which is also dependent on weather conditions and the two curves almost overlap, thus indicating that is would be impossible to allocate the use of the utilities.

The correct procedure, therefore, provides, from the historical estimate of consumption, for the subtraction of the patterns which are related to the utilities entered in the control panel and of which to generate the program (in the example of the figure only the washing machine, but that could be a washing machine and other utilities).

FIG. 7A, step 2, shows such subtraction.

At this point, as shown in FIG. 7B case “Schedule built on correct forecast (with pattern subtraction)” a correctly lower consumption line is highlighted compared to a final energy production line that is a function of the historical data but also of the weather forecast.

Having subtracted the consumptions linked to the utilities for which the schedule is to be made, the calculated consumptions are only the historical ones actually carried out by all and only those utilities not entered in the control panel because not of interest to the user (he/she does not want to enter them) or that cannot be entered no matter what. In fact, some utilities cannot be entered, in particular all those for which a program of use cannot be made such as the utilities for cooking, hair dryer etc.

The final result of the two overlapping graphs is, in this case, the presence of areas with a possible energy surplus (a function of weather conditions), within which to allocate the consumption of the entered utilities in order to power them as much as possible with renewable energy sources.

In the example of FIG. 7B there are indicated the “free areas” which have been calculated and which would be big enough to contain an example pattern_1.

This implies, as described above, that the activations/deactivations of the utilities entered in the control panel are allocated as a function of the dimensions of the calculated free areas (amount of energy surplus), which must be compatible (as can be inferred from FIG. 7B) with the known consumption by those utilities, As mentioned previously, an a priori consumption is known for each utility and such consumption is subtracted from the historical data.

Therefore, because the consumptions are known of the entered utilities, those are allocated in the most suitable surplus areas.

As can be inferred from FIG. 7B, said activation and/or deactivation schedule is a function of the areas of energy surplus and function of the known consumptions of the utilities. This way, the system appropriately allocates the activations of each utility in the most suitable areas.

Without prejudice to all of the above, in any case, the calculation function will best allocate the switching on/off times of the utilities so that they are powered as much as possible by the renewable sources.

Obviously, optimization can also result in a partial power supply with mains current but, in any case, everything described so far is aimed at best maximizing the use of energy from renewable sources.

The remotely controllable electronic household appliances can be of various kinds, such as washing machines, dishwashers, water heaters, air conditioners, heat pumps, but in general the common thread is that all these devices must produce a result within a predefined time. However, there are also devices that cannot be included in the consumption scheduling strategy, and those are the devices whose use has an intrinsic component of randomness at the time of need, such as television (and in general all devices in the entertainment area), oven, or cooking hob. One of the aspects of the present invention is the maintenance or even the improvement of comfort, and for this reason, the use program for the utilities preferably excludes some household appliances such as an electric oven, a hair dryer and all those utilities that have a random use that cannot be regulated as a matter of fact.

In all the configurations of the present invention, without prejudice to all that has been described, the control unit may not be installed directly in the dwelling but may be “in the cloud”.

In this case, the control unit may be in the form of a server reachable on the Internet and with the sensors that send data to that specific server that carries out the above-described processing.

In this case, the “remote” control unit, in the cloud, may be a virtualized control panel through mobile apps or other similar systems such as computer programs.

The system in all of the above-described configurations, in particular in the latter with a virtual control unit, lends itself well to an application (App) for mobile devices such as mobile telephony devices.

In the present description, the term dwelling means a building or a room in general for house and/or office use or rooms in general for industrial use (as in a factory), for warehouse use, and/or for commercial use and in any case any type of building/construction/room in the broad sense without any limitations as long as it has renewable energy sources and utilities that generate electrical consumption.

### CAPTIONS

(FV)=Photovoltaic panels
(CG)=Sensor to detect total consumption of the building in real time
(PF)=Sensor to detect photovoltaic production of the building in real time
(L)=A household appliance (e.g., a washing machine) that can be controlled electronically remotely
(C)=A control unit that implements and executes the efficiency logics.

The invention claimed is:

1. A method for optimizing electrical energy consumption from renewable sources in a dwelling, the method comprising:
determining electrical energy consumption in the dwelling over a first time interval based on historical data of electrical energy consumption over the first time interval;
determining electrical energy production from renewable sources present and in use in the dwelling over the first time interval based on historical data of electrical energy production over the first time interval;
entering, in a control unit, one or more utilities which are present in the dwelling and for which to generate an activation and/or deactivation schedule in a second time interval subsequent to the first time interval; and
generating the activation and/or deactivation schedule of the one or more utilities in the second time interval, the activation and/or deactivation schedule being obtained as a function of at least:
the historical data of energy consumption and production, and
forecasted weather data related to the second time interval,
whereby the activation and/or deactivation schedule indicates, within the second time interval, a series of times and/or time sub-intervals distributed in the second time interval in which the one or more of the entered utilities can be activated and/or deactivated.

2. The method according to claim 1, wherein the utilities comprise one or more of the following:
one or more air conditioning systems; or
one or more household appliances.

3. The method according to claim 1, wherein determining an electrical energy consumption in the dwelling comprises determining the electrical energy consumption with at least one first sensor that measures in real time the electrical energy consumption made, and wherein determining electrical energy production from renewable sources comprising determining the electrical energy production with at least one second sensor that measures in real time the electrical energy produced.

4. The method according to claim 3, wherein generating the activation and/or deactivation schedule comprises using a control unit that receives, as input, data coming from the at least one first and the second sensors and forecasted weather data, the control unit processing the input data according to a specific function.

5. The method according to claim 1, wherein generating the activation and/or deactivation schedule comprises using a control unit that receives, as input, the historical data of electrical energy consumption and production and the forecast weather data, the control unit processing according to a specific function the input data.

6. The method according to claim 1, wherein generating the activation and/or deactivation schedule providing access to one or more utilities with a control panel communicating with a control unit or through a cloud connection with a virtual control unit via a mobile device or a computer.

7. The method according to claim 1, wherein the activation and/or deactivation schedule is visible on a screen and indicates, based on a set time interval, a time slot and day on which to activate and/or deactivate predetermined utilities.

8. The method according to claim 1, wherein the historical data of electric energy consumption and production are provided continuously or at predetermined time intervals.

9. The method according to claim 1, further comprising the step of subtracting, from the function of the historical data of energy consumption, consumption patterns only to utilities entered in a control unit and whose schedule is to be generated, the function overlapping with an energy production function dependent on the historical data of the energy production and on the forecasted weather data so as to generate, from an overlap of the two functions, the activation and/or deactivation schedule as a function of energy surplus areas.

10. An assembly for optimizing electrical energy consumption coming from renewable sources in a dwelling, the assembly comprising:
a first sensor adapted to detect the electrical energy consumptions in real time of one or more utilities set up for use in the dwelling; and
a second sensor adapted to detect in real time energy production of renewable energy sources set up for use in the dwelling;
a control unit communicating with the first and the second sensor so as to receive, as input, data measured by the first and the second sensors, the control unit further receiving, as input, weather data;
wherein the control unit is programmed to calculate, based on the data received as input from the first and the second sensors, historical reference data of electrical energy consumption and electrical energy production from the renewable sources within a first time interval in which the data from the first and the second sensors were acquired,
wherein the control unit is further programmed to acquire, as input, data related to the one or more utilities which are present in the dwelling and of which to generate an activation and/or deactivation schedule over time,
wherein the control unit is further programmed to generate the activation and/or deactivation schedule of the one or more utilities in a second time interval subsequent to the first time interval, and
wherein the activation and/or deactivation schedule is produced as a function of:
the historical reference data of electrical energy consumption and production, and
forecasted weather data related to the second time interval for which to generate the activation and/or deactivation schedule,
whereby the activation and/or deactivation schedule indicates, within the second time interval, a series of times and/or time sub-intervals distributed in the second time interval in which to be able to activate and/or deactivate one or more of the one or more utilities.

11. The assembly according to claim 10, wherein the control unit estimates the times and/or time sub-intervals having an energy surplus, and wherein, based on the calculated energy surplus and the consumptions of the one or more utilities, the control unit provides a report one which of the one or more utilities to activate and/or deactivate in the second time interval.

12. The assembly according to claim 10, wherein consumption patterns related only to the one or more utilities which have been entered in the control unit and whose schedule is to be generated are subtracted from the historical reference data of the electrical energy consumption.
